(19) United States
(12) Patent Application Publication
(10) Pub. No.: US 2026/0148599 A1
(43) Pub. Date: May 28, 2026

(54) ELECTRIC LOCK AND KEYPAD MODULE THEREOF

(71) Applicant: TAIWAN FU HSING INDUSTRIAL CO., LTD., Kaohsiung City (TW)

(72) Inventors: Fu-Chih HUANG, Kaohsiung City (TW); CHIEN-CHIH CHIU, Kaohsiung City (TW)

(21) Appl. No.: 19/374,494

(22) Filed: Oct. 30, 2025

(30) Foreign Application Priority Data
Nov. 22, 2024 (TW) 113145181
Jul. 4, 2025 (TW) 114125511

(51) Int. Cl. G07C 9/00

(52) U.S. Cl. CPC G07C 9/00674; G07C 9/00563; G07C 9/00944

(57) ABSTRACT

An electric lock includes a casing, a lock assembly and a keypad module. The keypad module includes a mounting plate, a flat key panel and a circuit board. The mounting plate is fixed to the casing and formed with an opening. The flat key panel has a key area marked with a plurality of key characters and a surrounding area surrounding a keyhole of the lock assembly. The key area corresponds to the opening. The circuit board includes a circuit substrate arranged on the casing and corresponding to the opening, and a plurality of metal domes. The circuit substrate has a plurality of key electrodes corresponding to the plurality of key characters respectively. Each of the key electrodes is configured to generate a key signal when contacting a corresponding metal dome. The flat key panel is made of a soft material and integrally formed.

### BACKGROUND OF THE INVENTION

### 1. Field of the Invention

The present invention relates to an electric lock, and more particularly, to an electric lock with an improved keypad structure.

### 2. Description of the Prior Art

An electric lock usually has a keypad for receiving input from a user to perform unlocking or locking operations. Generally, the keypad of the electric lock can be a touch keypad or a push-button keypad. The touch keypad is configured to receive input from the user by touching, and the push-button keypad is configured to receive input from the user by pressing. In contrast to a flat appearance of the touch keypad, the push-button keypad typically has a plurality of raised keys for the user to press. In the prior art, due to structural limitations, the push-button keypad cannot have a flat appearance like the touch keypad, such that appearance design of the electric lock is limited.

### SUMMARY OF THE INVENTION

An electric lock of the present invention comprises a casing, a lock assembly and a keypad module. The lock assembly is arranged on the casing and formed with a keyhole. The keypad module comprises a mounting plate, a flat key panel and a circuit board. The mounting plate is fixed to a front side of the casing and formed with a first opening. The flat key panel is fixed on the mounting plate and configured to cover a front side of the mounting plate. The flat key panel has a key area marked with a plurality of key characters and a surrounding area extended from the key area and configured to surround the keyhole of the lock assembly. The key area corresponds to the first opening. The circuit board comprises a circuit substrate and a plurality of metal domes. The circuit substrate is arranged on the casing and corresponds to the first opening. The circuit substrate has a plurality of key electrodes corresponding to the plurality of key characters respectively. The plurality of metal domes are arranged on the circuit substrate. Each of the key electrodes is configured to generate a key signal when contacting a corresponding metal dome. The flat key panel is made of a soft material and integrally formed.

A keypad module of an electric lock of the present invention comprises a mounting plate, a flat key panel and a circuit board. The mounting plate is configured to be fixed to a casing of the electric lock and is formed with a first opening. The flat key panel is fixed on the mounting plate and configured to cover a front side of the mounting plate. The flat key panel has a key area marked with a plurality of key characters and a surrounding area extended from the key area and configured to surround a keyhole of the lock assembly of the electric lock. The key area corresponds to the first opening. The circuit board comprises a circuit substrate and a plurality of metal domes. The circuit substrate corresponds to the first opening. The circuit substrate has a plurality of key electrodes corresponding to the plurality of key characters respectively. The plurality of metal domes are arranged on the circuit substrate. Each of the key electrodes is configured to generate a key signal when contacting a corresponding metal dome. The flat key panel is made of a soft material and integrally formed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an electric lock according to a first embodiment of the present invention;

FIG. 2 is an exploded view of the electric lock according to the first embodiment of the present invention;

FIG. 3 is a diagram showing an inner side of a flat key panel of the electric lock according to the first embodiment of the present invention;

FIG. 4 is a partial cross-sectional view of the electric lock according to the first embodiment of the present invention;

FIG. 5 is another partial cross-sectional view of the electric lock according to the first embodiment of the present invention;

FIG. 6 is an exploded view of an electric lock according to a second embodiment of the present invention;

FIG. 7 is a partial cross-sectional view of the electric lock according to the second embodiment of the present invention;

FIG. 8 is a diagram showing an electric lock according to a third embodiment of the present invention; and

FIG. 9 is an exploded view of the electric lock according to the third embodiment of the present invention.

### DETAILED DESCRIPTION

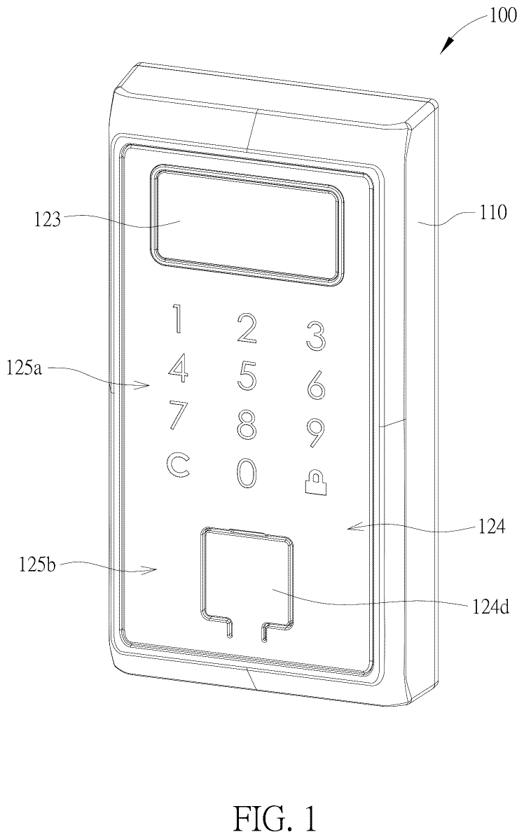

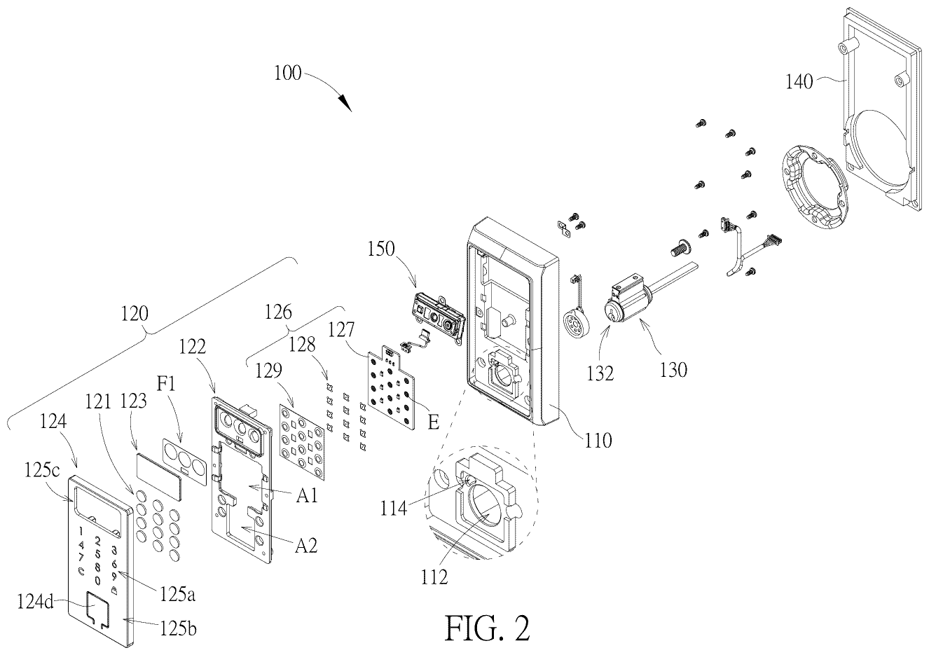

Please refer to FIG. 1 and FIG. 2. FIG. 1 is a diagram showing an electric lock 100 according to a first embodiment of the present invention. FIG. 2 is an exploded view of the electric lock 100 according to the first embodiment of the present invention. According to the first embodiment of the present invention, the electric lock 100 comprises a casing 110, a keypad module 120, and a lock assembly 130. The keypad module 120 is arranged on the casing 110, such as being fixed to a front side of the casing 110. The keypad module 120 comprises a mounting plate 122, a flat key panel 124, and a circuit board 126. The mounting plate 122 is fixed to the front side of the casing 110. The mounting plate 122 is formed with a first opening A1 and a second opening A2. The first opening A1 is communicated with the second opening A2. The flat key panel 124 is fixed on the mounting plate 122 and configured to cover a front side of the mounting plate 122. The flat key panel 124 has a key area 125a marked with a plurality of key characters. The plurality of key characters can be printed Arabic numerals or graphic symbols, but the present invention is not limited thereto. The key area 125a of the flat key panel 124 corresponds to the first opening A1 of the mounting plate 122. The flat key panel 124 is made of a soft material and integrally formed. For example, the flat key panel 124 is integrally formed from a silicone material, but the present invention is not limited thereto. The circuit board 126 comprises a circuit substrate 127 and a plurality of metal domes 128. The circuit substrate 127 is arranged on the casing 110 and corresponds to the first opening A1 of the mounting plate 122. The circuit substrate 127 has a plurality of key electrodes E corresponding to the plurality of key characters on the flat key panel 124 respectively. The metal domes 128 are arranged on the circuit substrate 127. Each of the key electrodes E is configured to generate a key signal when contacting a corresponding metal dome 128. The circuit board 126 further comprises an adhesive film 129 configured to affix the metal domes 128 to the circuit substrate 127. In the present embodiment, the lock assembly 130 is mounted to a mounting hole 112 of the casing 110. The lock assembly 130 comprises a lock cylinder formed with a keyhole 132. The lock cylinder of the lock assembly 130 is configured to be driven by a key to further move a latch (not shown in figures). The lock assembly 130 corresponds to the second opening A2 of the mounting plate 122. In addition, the flat key panel 124 further has a surrounding area 125b extended from the key area 125a. The surrounding area 125b is configured to surround the keyhole 132 of the lock assembly 130.

On the other hand, the electric lock 100 of the present invention can further comprise a control module (not shown in figures) configured to perform unlocking or locking operations according to the key signal generated by the keypad module 120. For example, the control module can comprise a motor and a driving mechanism. When the key signal generated by the keypad module 120 corresponds to or matches authentication data pre-stored in the control module, the control module can accordingly perform an unlocking operation (such as activating the motor to drive the driving mechanism to move a latch assembly of the electric lock 100 for performing the unlocking operation). On the other hand, when the key signal generated by the keypad module 120 corresponds to or matches a locking command, the control module can perform a locking operation (such as activating the motor to drive the driving mechanism to move the latch assembly of the electric lock 100 for performing the locking operation). In other embodiments of the present invention, the control module can comprise a motor and a clutch mechanism, such that the motor is configured to drive the clutch mechanism to engage an outer handle with the latch assembly or disengage the outer handle from the latch assembly according to the key signal generated by the keypad module 120, in order to perform the unlocking operation or the locking operation.

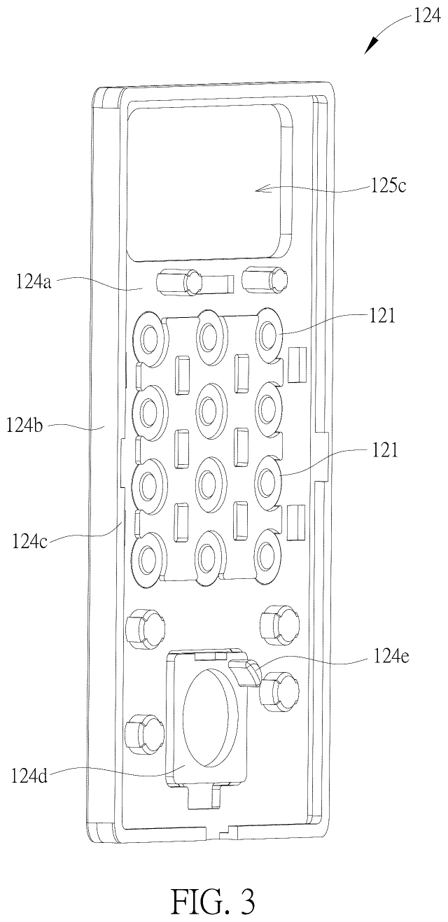

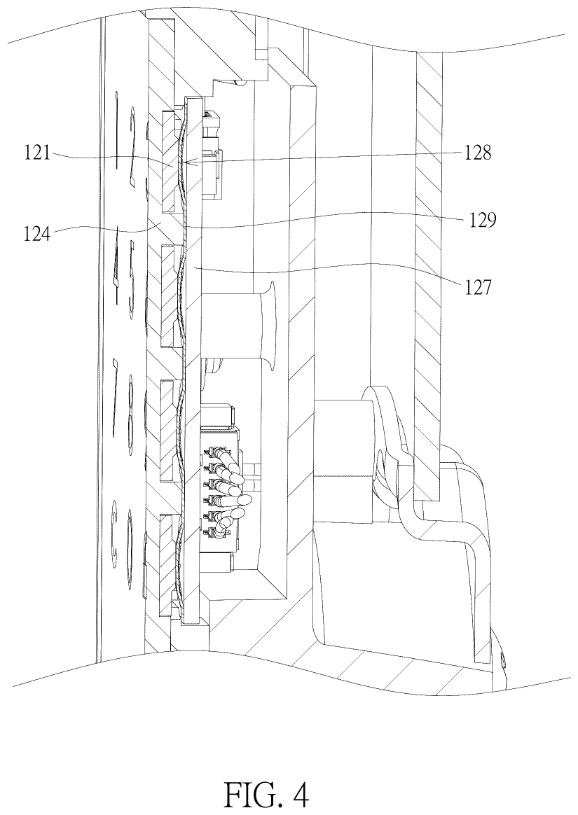

Please refer to FIG. 3 and FIG. 4, and refer to FIG. 1 and FIG. 2 as well. FIG. 3 is a diagram showing an inner side of the flat key panel 124 of the electric lock 100 according to the first embodiment of the present invention. FIG. 4 is a partial cross-sectional view of the electric lock 100 according to the first embodiment of the present invention. As shown in the figures, the keypad module 120 further comprises a plurality of pressing pads 121 arranged at the inner side of the flat key panel 124. The plurality of pressing pads 121 correspond to the plurality of key characters on the flat key panel 124 respectively. The pressing pads 121 is harder than the flat key panel 124. For example, the pressing pad 121 can be made of hard plastic through injection molding, but the present invention is not limited thereto. When one of the key characters on the flat key panel 124 is pressed, the flat key panel 124 further presses a corresponding metal dome 128 through the pressing pad 121 in order to deform the corresponding metal dome 128 (for example, the corresponding metal dome 128 is recessed inwardly), so as to allow the deformed metal dome 128 to contact the corresponding key electrode E to generate a key signal.

According to the above configuration, even though the keypad module 120 of the electric lock 100 of the present invention is a push-button keypad, an outer side of the keypad module 120 can be formed with a flat surface. In other words, the keypad module 120 of the electric lock 100 of the present invention can have a flat appearance (without raised keys) similar to that of a touch keypad. Furthermore, the flat key panel 124 is made of a soft material (such as silicone) and is integrally formed, and the pressing pad 121 is made of a harder material. Therefore, when the user presses the keypad module 120, the flat key panel 124 can provide a softer touch feeling to the user, and the pressing pad 121 can allow the user to clearly feel the click when pressing the keypad module 120.

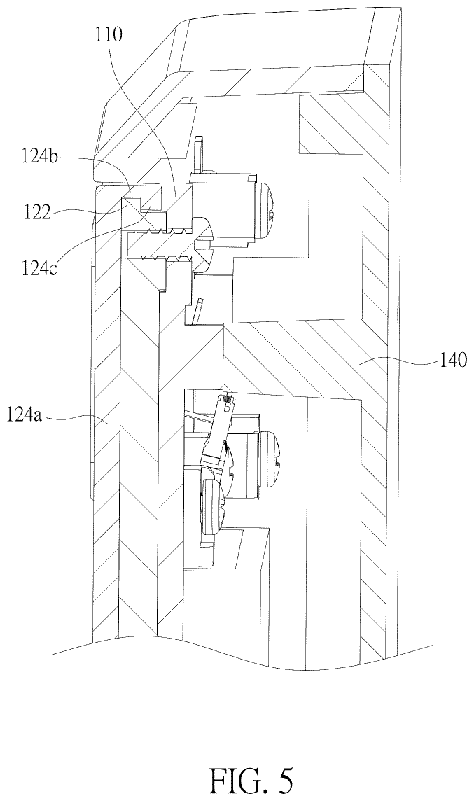

Please refer to FIG. 3 and FIG. 5, and refer to FIG. 1 and FIG. 2 as well. FIG. 5 is another partial cross-sectional view of the electric lock 100 according to the first embodiment of the present invention. As shown in figures, the flat key panel 124 comprises a flat main body 124a, an extension part 124b, a covering part 124c, and a flip cover part 124d. The flat main body 124a is configured to cover the front side of the mounting plate 122. The extension part 124b is extended from the flat main body 124a toward the mounting plate 122. The covering part 124c is connected to the extension part 124b and configured to cover a rear edge of the mounting plate 122 in order to fix the flat key panel 124 to the mounting plate 122. In the present embodiment, the covering part 124c is configured to surround and cover all rear edges of the mounting plate 122. On the other hand, the mounting plate 122 can be screwed to the front side of the casing 110 to fix the covering part 124c between the mounting plate 122 and the casing 110. The flip cover part 124d is extended from the surrounding area 125b of the flat main body 124a to cover the keyhole 132 of the lock assembly 130. The flip cover part 124d is arranged with a protrusion 124e (as shown in FIG. 3) to support the flip cover part 124d. For example, the casing 110 has a recessed part 114 (as shown in FIG. 2). The protrusion 124e is configured to extend into and abut against the recessed part 114 to further fix and support the flip cover part 124d, in order to prevent the flip cover part 124d from being protruded or recessed relative to the surrounding area 125b. Thereby, the flip cover part 124d is flush with the flat key panel 124. Furthermore, a narrow slit is formed around the flip cover part 125b to allow the user to flip up the flip cover part 124d relative to the surrounding area 125b to further insert a key into the keyhole 132, in order to perform unlocking or locking operations. In the present embodiment, the flip cover part 124d is in a square shape. The narrow slit partially surrounds the flip cover part 124d in order to allow the flip cover part 124d to be in a state of being partially separated from the surrounding area 125b of the flat key panel 124 (without being completely separated from the surrounding area 125b of the flat key panel 124). Furthermore, the flip cover part 124d is thinner than the surrounding area 125b of the flat key panel 124, such that the flip cover part 124d is easy to bend from a junction between the flip cover part 124d and the surrounding area 125b of the flat key panel 124 when the flip cover part 124d is flipped up. Since the flat key panel 124 is made of a silicone material, the junction between the flip cover part 124d and the surrounding area 125b of the flat key panel 124 is not easy to break, so as to enhance product durability.

According to the above arrangement, the keypad module 120 of the electric lock 100 of the present invention has a flat appearance, and the flat key panel 124 of the keypad module 120 can also provides a waterproof effect to prevent water from entering the front side of the electric lock 100. Moreover, a front flat surface of the flat key panel 124 of the present invention is extended from the key area 125a through the surrounding area 125b to the flip cover part 124d, such that a front appearance of the electric lock 100 of the present invention is neat and integrated, so as to enhance perceived value of the product. In addition, an outer edge of the flat key panel 124 can also be further extended to the two lateral surfaces, a top surface, and a bottom surface of the electric lock 100.

In addition, the electric lock 100 of the present invention can further comprise a waterproof pad 140 and a biometric recognition module 150. The waterproof pad 140 is arranged at a rear side of the casing 110 in order to prevent

water from entering a rear side of the electric lock 100. The biometric recognition module 150 is arranged on the casing 110. The flat key panel 124 is formed with an opening 125c corresponding to the biometric recognition module 150. In the present embodiment of the present invention, the biometric recognition module 150 is a facial recognition module, but the present invention is not limited thereto. The biometric recognition module 150 cam also be a fingerprint recognition module or another type of recognition module. The keypad module 120 can further comprise a transparent cover 123 fixed to the mounting plate 122 by a double-sided adhesive film F1. The transparent cover 123 is substantially flush with the flat keypad panel 124 to be seemed as a flat surface on the front side of the electric lock 100.

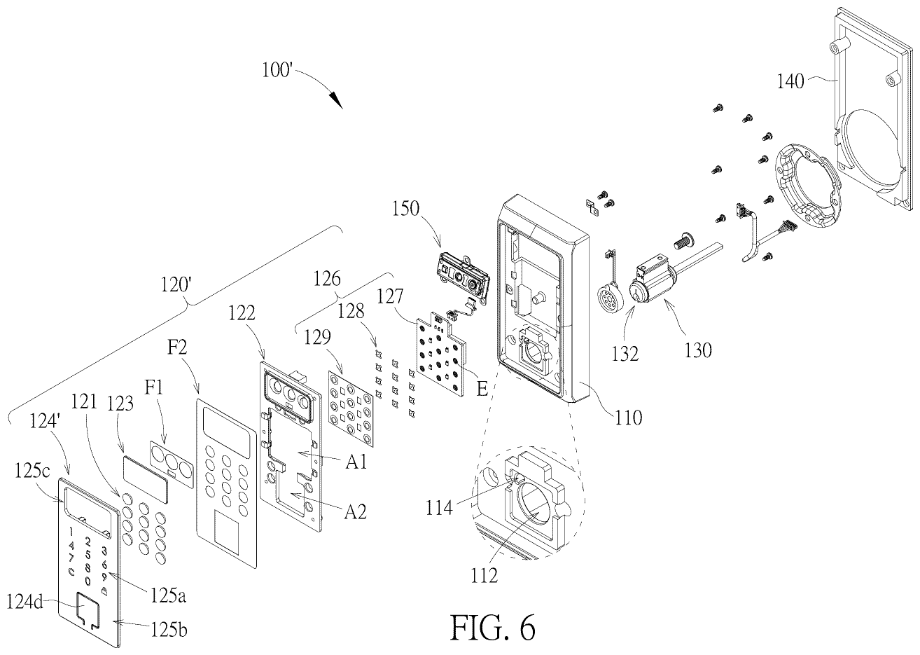

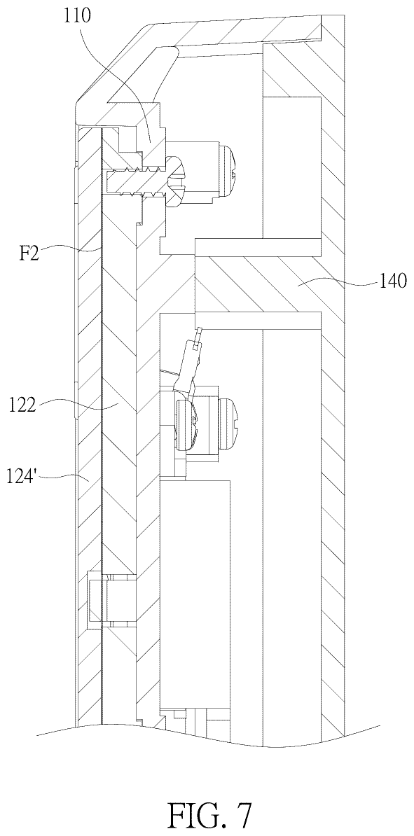

Please refer to FIG. 6 and FIG. 7, and refer to FIG. 1 as well. FIG. 6 is an exploded view of an electric lock 100′ according to a second embodiment of the present invention. FIG. 7 is a partial cross-sectional view of the electric lock 100′ according to the second embodiment of the present invention. An appearance of the electric lock 100′ in the second embodiment of the present invention is identical to that of the electric lock 100 in the first embodiment of the present invention. Different from the first embodiment, a flat key panel 124′ of the electric lock 100′ according to the second embodiment of the present invention does not have an extension part and a covering part. The electric lock 100′ further comprises an adhesive layer F2 arranged between the flat key panel 124′ and the mounting plate 122, in order to adhere and fix the flat key panel 124′ to the front side of the mounting plate 122. A silicone adhesive can be used to form the adhesive layer F2. Other components of the electric lock 100′ of the second embodiment of the present invention are identical to those of the electric lock 100 of the first embodiment of the present invention.

A keypad module 120′ of the electric lock 100′ of the present invention can also have a flat appearance (without raised keys) similar to that of a touch keypad. Furthermore, the flat key panel 124′ is made of a soft material (such as silicone) and is integrally formed, and the pressing pad 121 is made of a harder material. Therefore, when the user presses

the keypad module 120′, the flat key panel 124′ can provide a softer touch feeling to the user, and the pressing pad 121 can allow the user to clearly feel the click when pressing the keypad module 120′.

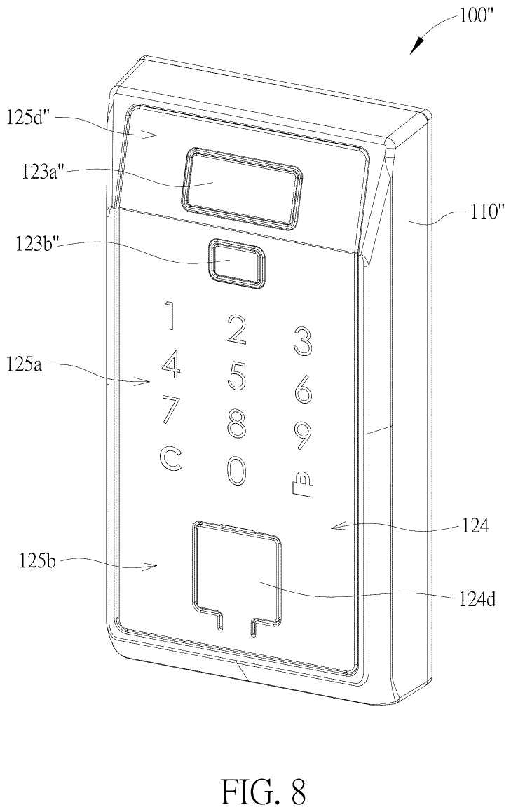

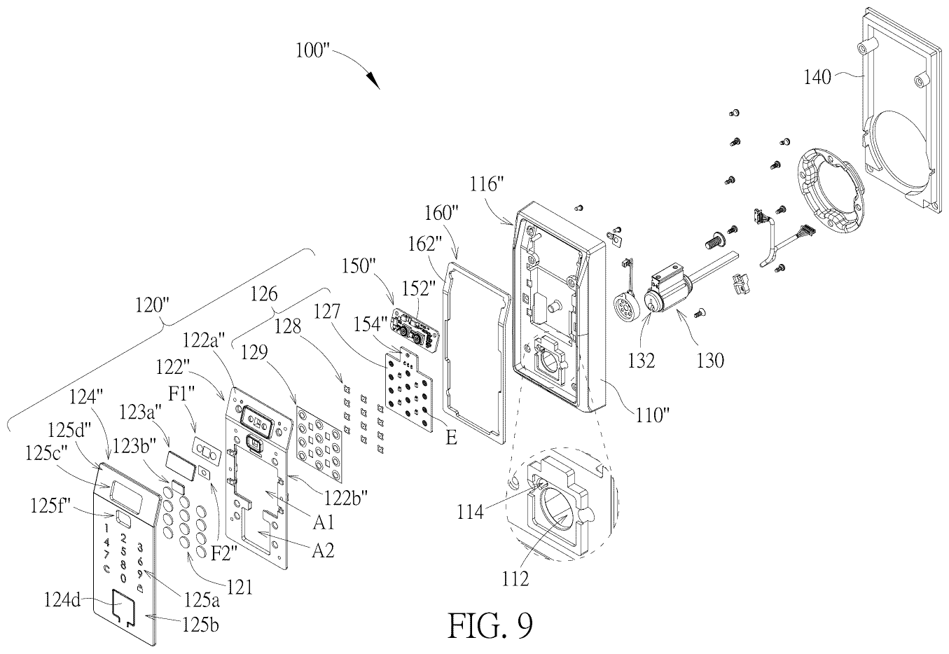

Please refer to FIG. 8 and FIG. 9. FIG. 8 is a diagram showing an electric lock 100″ according to a third embodiment of the present invention. FIG. 9 is an exploded view of the electric lock 100″ according to the third embodiment of the present invention. A main difference between the electric lock 100″ of the third embodiment of the present invention and the electric lock 100′ of the second embodiment of the present invention is that an upper part 122a″ of a mounting plate 122″ of the electric lock 100″ is inclined at a predetermined angle (e.g., 16 degrees, but the present invention is not limited thereto) relative to a main body part 122b″ of the mounting plate 122″. The upper part 122a″ of the mounting plate 122″ is configured to mount a camera module 152″ of a biometric recognition module 150″ (such as a facial recognition module, but the present invention is not limited thereto). The camera module 152″ of the biometric recognition module 150″ is configured to capture a face image of the user. In addition, the flat key panel 124″ of the electric lock 100″ further has an inclined area 125d″ inclined at the predetermined angle relative to the key area 125a to correspond to the upper part 122a″ of the mounting plate 122″. The inclined area 125d″ is formed with a first opening 125c″ corresponding to the camera module 152″ of the biometric recognition module 150″. Correspondingly, a casing 110″ of the electric lock 100″ is formed with an inclined structure 116″ corresponding to the upper part 122a″ of the mounting plate 122″, such that the mounting plate 122″ can be installed and fixed on the casing 110″. The flat key panel 124″ can be fixed to the mounting plate 122″ by a double-sided adhesive film (not shown). Furthermore, a keypad module 120″ of the electric lock 100″ can further comprise a first transparent cover 123a″ fixed to the upper part 122a″ of the mounting plate 122″ by a double-sided adhesive film F1″. The first transparent cover 123a″ corresponds to the camera module 152″.

On the other hand, the biometric recognition module 150″ further comprises a time-of-flight (TOF) sensing module 154″ configured to scan three-dimensional facial contour of the user. The key area 125a of the flat key panel 124″ is formed with a second opening 125f″ corresponding to the time-of-flight sensing module 154″. Furthermore, the keypad module 120″ can further comprise a second transparent cover 123b″ fixed to the main body part 122b″ of the mounting plate 122″ by a double-sided adhesive film F2″. The second transparent cover 123b″ corresponds to the time-of-flight sensing module 154″. The time-of-flight sensing module 154″ is configured to work with the camera module 152″ to perform facial recognition operations of the electric lock 100″.

According to the above arrangement, the camera module 152″ of the biometric recognition module 150″ is slightly tilted upward, such that the electric lock 100″ can perform facial recognition operations without requiring the user to lower his head.

In addition, the electric lock 100″ further comprises a waterproof gasket 160″ arranged between the mounting plate 122″ and the casing 110″. The waterproof gasket 160″ has a bending part 162″ corresponding to the upper part 122a″ of the mounting plate 122″ in order to enhance the waterproof effect of the keyboard module 120″.

In contrast to the prior art, the keypad modules 120, 120′, 120″ of the electric locks 100, 100', 100″ of the present invention can have the flat appearance similar to that of a touch keypad. Furthermore, when the user presses the keypad modules 120, 120′, 120″, the flat key panel 124 provides a softer touch feeling to the user, and the pressing pad 121 can allow the user to clearly feel the click when pressing the keypad module 120, 120′. Furthermore, the flat key panel 124 of the electric lock 100 of the present invention has a covering part 124c that completely covers the rear edge of the mounting plate 122, thereby enhancing the waterproof effect of the electric lock 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electric lock, comprising:
a casing;
a lock assembly arranged on the casing and formed with a keyhole; and
a keypad module, comprising:
a mounting plate fixed to a front side of the casing and formed with a first opening;
a flat key panel fixed on the mounting plate and configured to cover a front side of the mounting plate, wherein the flat key panel has a key area marked with a plurality of key characters and a surrounding area extended from the key area and configured to surround the keyhole of the lock assembly, wherein the key area corresponds to the first opening; and
a circuit board, comprising:
a circuit substrate arranged on the casing and corresponding to the first opening, wherein the circuit substrate has a plurality of key electrodes corresponding to the plurality of key characters respectively; and
a plurality of metal domes arranged on the circuit substrate, wherein each of the key electrodes is configured to generate a key signal when contacting a corresponding metal dome;
wherein the flat key panel is made of a soft material and integrally formed.

2. The electric lock of claim 1, wherein the flat key panel is made of a silicone material and integrally formed.

3. The electric lock of claim 1, wherein the flat key panel comprises:
a flat main body configured to cover the front side of the mounting plate, wherein the flat main body has the key area and the surrounding area;
an extension part extended from the flat main body toward the mounting plate; and
a covering part configured to cover a rear edge of the mounting plate to fix the flat key panel to the mounting plate.

4. The electric lock of claim 3, wherein the covering part is fixed between the mounting plate and the casing.

5. The electric lock of claim 3, wherein the flat key panel further comprises a flip cover part extended from the surrounding area to cover the lock assembly, and the flip cover part is arranged with a protrusion configured to abut against the casing.

6. The electric lock of claim 1, wherein the mounting plate is further formed with a second opening, and the lock assembly corresponds to the second opening.

7. The electric lock of claim 1, further comprising an adhesive layer arranged between the flat key panel and the mounting plate and configured to fix the flat key panel to the front side of the mounting plate.

8. The electric lock of claim 1, wherein the keypad module further comprises a plurality of pressing pads arranged at an inner side of the flat key panel and corresponding to the plurality of key characters respectively; wherein the pressing pads is harder than the flat key panel.

9. The electric lock of claim 1, further comprising a waterproof pad arranged at a rear side of the casing.

10. The electric lock of claim 1, further comprising a biometric recognition module arranged on the casing, wherein the flat key panel is formed with an opening corresponding to the biometric recognition module.

11. The electric lock of claim 10, wherein the biometric recognition module is a face recognition module.

12. A keypad module of an electric lock, comprising:
a mounting plate configured to be fixed to a casing of the electric lock, wherein the mounting plate is formed with a first opening;
a flat key panel fixed on the mounting plate and configured to cover a front side of the mounting plate, wherein the flat key panel has a key area marked with a plurality of key characters and a surrounding area extended from the key area and configured to surround a keyhole of the lock assembly of the electric lock, wherein the key area corresponds to the first opening; and
a circuit board, comprising:
a circuit substrate corresponding to the first opening, wherein the circuit substrate has a plurality of key electrodes corresponding to the plurality of key characters respectively ; and
a plurality of metal domes arranged on the circuit substrate, wherein each of the key electrodes is configured to generate a key signal when contacting a corresponding metal dome;
wherein the flat key panel is made of a soft material and integrally formed.

13. The keypad module of the electric lock of claim 12, wherein the flat key panel is made of a silicone material and integrally formed.

14. The keypad module of the electric lock of claim 12, wherein the flat key panel comprises:
a flat body configured to cover the front side of the mounting plate, wherein the flat body has the key area and the surrounding area;
an extension part extended from the flat body toward the mounting plate; and
a covering part configured to cover a rear edge of the mounting plate to fix the flat key panel to the mounting plate.

15. The keypad module of the electric lock of claim 14, wherein the flat key panel further comprises a flip cover part extended from the surrounding area to cover the keyhole of the lock assembly, and the flip cover part is arranged with a protrusion configured to abut against the casing.

16. The keypad module of the electric lock of claim 14, wherein the flat key panel further comprises a flip cover part extended from the surrounding area to cover the keyhole of the lock assembly, and the flip cover part is thinner than the surrounding area.

17. The keypad module of the electric lock of claim 12, wherein the mounting plate is further formed with a second opening, and the lock assembly corresponds to the second opening.

18. The keypad module of the electric lock of claim 12, further comprising an adhesive layer arranged between the flat key panel and the mounting plate and configured to fix the flat key panel to the front side of the mounting plate.

19. The keypad module of the electric lock of claim 12, further comprising a plurality of pressing pads arranged at an inner side of the flat key panel and corresponding to the plurality of key characters respectively, wherein the pressing pads is harder than the flat key panel.

20. The keypad module of the electric lock of claim 12, wherein the mounting plate has an upper part and a main body part, the upper part is inclined at a predetermined angle relative to the main body part, wherein the upper part is configured to mount a biometric recognition module, the flat key panel further has an inclined area inclined at the predetermined angle relative to the key area to correspond to the upper part of the mounting plate.
